(19) United States
(12) Patent Application Publication
(10) Pub. No.: US 2007/0160799 A1
(43) Pub. Date: Jul. 12, 2007

(54) Moldable composite article

(76) Inventor: Hung Manh Nguyen, Charlotte, NC (US)

Correspondence Address: INVISTA NORTH AMERICA S.A.R.L., THE LITTLE FALLS CENTRE/1052, 2801 CENTERVILLE ROAD, WILMINGTON, DE, 19808, US

(21) Appl. No.: 10/588,117

(22) PCT Filed: Feb. 4, 2005
(86) PCT No.: PCT/US05/03683

§ 371 Date: Aug. 1, 2006

(30) Foreign Application Priority Data
Feb. 6, 2004 (US) 10773490

(51) Int. Cl. B32B 3/00; B29C 45/14; B27N 3/10

(52) U.S. Cl. 428/74; 264/257

(57) ABSTRACT

The present invention relates to moldable composite articles, and particularly to a molded nonwoven fibrous article, and specifically to an automobile headliner that has improved physical properties at low weight. There is a need to minimize the weight of the headliner and the critical parameter is minimum sag. For a molded non-needlepunched batt in the weight range of 1000 to 1200 grams per square meter (gsm), the sag at 91° C. must be less than 10 mm, when cantilevering a distance of 28 cm. The stiffness, strength and toughness of the batt should be greater than 2 N/mm, 17N and 70% respectively. In the first embodiment, the thermoplastic binder is a bicomponent fiber with an adhesion promoted polyolefin sheath and a polyester core. In the second embodiment, the matrix fiber is a synthetic fiber with a modulus greater than 10 cN/tex. In the third embodiment the matrix fiber is a natural fiber. In the fourth embodiment the bicomponent fiber contains a filler such as carbon black or titanium dioxide.

### BACKGROUND OF THE INVENTION

This invention claims the priority of U.S. Provisional Application 60/542,202, filed Feb. 5, 2004.

### FIELD OF THE INVENTION

The invention relates to moldable composite articles, such as those found in planes, cars, trucks, housing, and construction equipment. In particular, the present invention relates to a molded nonwoven fibrous article, and specifically to an automobile headliner that has improved physical properties at low weight. Chief among those physical properties are sag, strength, stiffness and toughness.

### PRIOR ART

Composite material panels are used in many different applications, including automobiles, airplanes, housing and building construction. The properties sought in such panels are strength, rigidity, sound absorption, and heat and moisture resistance. One application of such panels, which has been especially challenging is automobile headliners. Many different types of laminates and laminated composites have been tested and produced for use in automobiles. Some headliners have a core of fiberglass fibers and a polyester resin. Others have been manufactured from a core of open cell polyurethane foam impregnated with a thermosetting resin, and with a reinforcing layer of fiberglass. These types of construction are inefficient in mass production, and have low acoustical attenuation which is particularly undesirable for automobile headliners.

Other approaches have been to form a laminate of fiber reinforcing mat, such as a glass fiber mat on a fibrous core, and a second reinforcing mat on the opposite side. The exposed surfaces of the reinforcing mat are then coated with a resin, and an outer cover stock is then applied. This laminate is then formed to a desired shape under heat and pressure, i.e., compression molding.

Although layers containing fiberglass have the desirable characteristics of strength and some sound attenuation, they have the undesirable traits of reflecting sound when made very hard or dense. Fiberglass, particularly in woven mat form, is also difficult to handle and is a known skin irritant. This is a significant problem because the production of headliners and similar panels using fiberglass is most commonly done manually.

However, a significant limitation of the fiberglass headliner is its brittleness. Because of the relative inflexibility and brittleness of the fiberglass headliner, it is easily fractured or broken during shipment from the manufacturing site to the vehicle assembly plant. The headliner is also subject to damage or breakage during installation, since any significant bending or flexing of the headliner would result in breakage or in a permanent crease. Accordingly, care must be exercised in installing the headliner. Its size and rigidity requires that it be installed through a large opening such as the windshield or rear window opening prior to installation of the glass. Similar problems are encountered with rigid foam headliners.

U.S. Pat. No. 4,840,832 to Weinle et al. solved the problems encountered with fiberglass composites by using a batt of polymeric fibers compressed and molded into the desired headliner shape. Rolls of the web are created by blending the fibers, carding, cross-lapping and needlepunching the web, just before it is wound. The fibers of the batt are then cut and heat bonded together at a multiplicity of locations to impart to the panel a self-supporting molded rigidity to allow the headliner to retain its shape in the installed condition in the vehicle, yet rendering the panel highly deformable and resilient to allow it to be flexed during installation and thereafter to recover resiliently to its original molded shape. The polymeric fibers of the batt preferably include binder fibers which are thermally activated during the molding of the batt to bond the fibers of the batt at their crossover points, thereby maintaining the batt in its molded shape while providing resiliency and flexibility to the batt. Especially suitable as binder fibers are bicomponent fibers having a relatively low melting polymer binder component and a higher melting polymer strength component. Weinle et al. solely disclosed a batt formed form a blend of 25% conventional polyethylene terephthalate (PET) fibers and 75% sheath/core PET copolymer/PET homopolymer binder fibers. The example showed that the PET batt could be bent at a higher angle than a resin bonded fiberglass control.

U.S. Pat. No. 6,582,639 to Nellis noted that the thermoplastic fiber batts of Weinle et al. could exhibit excessive loss of thickness upon heating, which can prevent complete filling of the headliner mold. When this occurs, the resulting headliner does not have the desired predetermined shape, and must be scraped. Moreover, the thermoplastic fiber batts of Weinle et al. exhibited poor loft retention during heating. Nellis solved these problems by utilizing non-circular cross-section fibers, controlling the temperature of the batt during molding, and increasing the degree of crystallinity of the polyester sheath of the bicomponent binder fiber.

U.S. Pat. Application No. 2001/0036788 to Sandoe et al. also noted that the headliners of Weinle do not have sufficient rigidity to avoid sag when subjected to elevated summer time temperatures normally experienced in vehicles, except when the mass and density of the headliners are high. Sandoe et al. disclose a laminate comprising first and second strengthening outer layers and a core layer between the strengthening layers. Each of the outer layers comprises a batt of nonwoven polymeric fibers. The outer layer provides the flexural rigidity for the laminate and the core layer provides the sound absorption for the laminate. The core layer batt preferably comprises 20-50% fine fibers, preferably with a denier less than 2.7, 10-50% binder fibers and the balance regular fibers with a denier in the range of 4.0-15.0. The thermoplastic fibers can include polyester, polyolefin, and nylon. The polyester fibers preferably include bicomponent fibers, such as a PET sheath-core bicomponent fiber. The core layer comprises regular fibers having a denier greater than the fine fibers of the core layer and in an amount to provide flexural rigidity to the laminate.

In prior art nonwoven structures for molded articles a low melting copolyester sheath is used with a polyester core. In other applications such as nonwovens for diapers, incontinent pads, sanitary napkins, wound dressing pads in which an absorbent such as wood pulp is used, the bicomponent fiber is olefin based, with a polyethylene sheath. Improved nonwoven mechanical properties were achieved by adding adhesion promoters to the polyethylene. U.S. Pat. Nos. 4,950,541 and 5,372,885 to Tabor, et al. disclose the use of maleic acid or maleic anhydride grafted polyethylene.

U.S. Patent Application 2003/0207639 to Lin discloses the use of tackifiers and adhesion promoters in the binder fiber for improved adhesion. Ethylene-acrylic copolymers, and a combination of this with the grafted polyolefins mentioned, are suitable adhesion promoters. Commercially available maleic anhydride grafted polyethylene are known as ASPUN resins from Dow Chemical. Commercially available ethylene-acrylic copolymers are Bynel 2022, Bynol 21E533 and Fusabond MC 190D from DuPont, and the Escor acid terpolymers from ExxonMobil. Commercially available rosin based tackifiers are Foral 85 from Hercules, Inc., Permylyn 2085 from Eastman Chemicals and Escorez 5400 from Mobil Exxon Chemical.

In spite of these improvements in laminates for molded articles such as automobile headliners there is still a need to reduce weight in molded articles that maintain the required balance of physical properties at lower weights and to reduce sag. Normal binder materials or typical binder amounts for nonwovens are generally insufficient to meet the sag limitations of this invention.

### SUMMARY OF THE INVENTION

In the first embodiment, the thermoplastic binder is a bicomponent fiber with an adhesion promoted polyolefin sheath and a polyester core. In the second embodiment, the matrix fiber is a polyester fiber with a modulus greater than 10 cN/tex. In the third embodiment the matrix fiber is a natural fiber. In the fourth embodiment the bicomponent fiber contains filler such as carbon black or titanium dioxide.

Accordingly, in the broadest sense, the present invention is directed to a nonwoven molded article, wherein the article comprises synthetic fibers and a bicomponent fiber binder, said binder having a low melt component of an adhesion promoted polyolefin.

Also in the broadest sense, the present invention is directed to a nonwoven molded article, wherein the article comprises synthetic fibers and a bicomponent fiber binder, said binder having a low melt component of an adhesion promoted polyolefin containing filler.

In the broadest sense the present invention also comprises a molded article of synthetic fiber and a bicomponent binder, said synthetic fiber having a modulus of at least 10 cN/tex, and said binder having a low melt component of an adhesion promoted polyolefin.

Also in the broadest sense, the present invention comprises a molded article of natural fiber and a bicomponent binder, said binder having a low melt component of an adhesion promoted polyolefin.

### DETAILED DESCRIPTION OF THE PREFERRED EMBODIMENTS

The key physical properties of molded articles are their sag, strength, stiffness and toughness. For instance, it is important that the automotive headliners do not sag at the inside temperature of an automobile parked in sunlight, and therefore this property is measured at a temperature in the range of 85° to 100° C. A headliner also needs rigidity (stiffness) to allow it to retain its shape in the installed condition in the vehicle, yet rendering the panel highly deformable and resilient to allow it to be flexed during installation (toughness) and thereafter to recover to its original molded shape. Other molded articles are door panels, hood liners above the engine, trunk liners for the ceiling, floor and side walls, and wall panels for housing. Other vehicles such as trucks, planes, and construction equipment also use molded articles. For ease of description, only headliners will be used, but those skilled in the art recognize their application for other uses.

There is a need to minimize the weight of the headliner and the critical parameter is minimum sag. For a batt, prior to needle punching, in the weight range of 1000 to 1200 grams per square meter (gsm), the sag at 91° C. must be less than 10 mm, when cantilevering a distance of 28 cm. The stiffness, strength and toughness of this batt should also be greater than 2 N/mm, 17N and 70% respectively.

Batts of the present invention can be made by either dry laid or wet laid processes. Dry laid webs are made by the airlay, carding, garnetting, or random carding processes. Air laid webs are created by introducing the fibers into an air current, which uniformly mixes the fibers and then deposits them on a screen surface. The carding process separates tufts into individual fibers by combing or raking the fibers into a parallel alignment. Garnetting is similar to carding in that the fibers are combed. Thereafter the combed fibers are interlocked to form a web. Multiple webs can be overlapped to build up a desired weight. Random carding uses centrifugal force to throw fibers into a web with random orientation of the fibers. Again multilayers can be created to obtain the desired web weight. Wet laid webs are made by a modified papermaking process. The fibers are blended together, suspended in water, decanted on a screen, dried and bonded together. The nonwoven batt is generally needle punched to give the batt sufficient coherency to be handled and formed into a roll. Alternatively the nonwoven batts may be made by a spunbond process in which continuous filaments are spun and drawn and laid on a belt.

The batt is thereafter unrolled and cut to size, and optionally combined with a foam layer and a fabric surface layer. These materials are heated, at a temperature and for a time sufficient to activate the potentially adhesive characteristics of the thermoplastic binder fibers. The heated fibrous batt is then molded and cooled into the desired contoured configuration. After the batt has cooled sufficiently, it is removed from the mold and cut and trimmed into the finished size. An alternative fabrication method involves placing the batt in the mold without preheating and heating the batt to the fusion and molding temperature by forcing heated air or steam through the batt while it is in the mold.

Bicomponent fibers in which one component has a lower melting point than the other have traditionally been used as binders in nonwoven structures. On heating the nonwoven structure the lower melting point component melts and forms a bond with the other fibers. Bicomponent fibers can be of the type in which the low melting portion is adjacent to the high melting portion such as a side-by-side configuration, or a sheath-core configuration where the sheath is the low melting component and the core is the high melting component. The low melting portion, in a suitable bicomponent fiber melts at a temperature of at least about 5° C. lower than said high melting portion. The proportion by weight of low melting component to high melting component is from about 90/10 to about 10/90. Preferably the components are in a range from about 45/55 to 55/45. A 50/50 ratio is most preferred.

It has been found that the use of adhesion promoted polyolefin sheath/polyester core bicomponent fibers give improved molded structure physical properties. The adhesion promoters are polyolefins grafted with maleic acid or maleic anhydride (MAH), both of which convert to succinic acid or succinic anhydride upon grafting to the polyolefin. The preferred incorporated MAH graft level is 10% by weight (by titration). Also, ethylene-acrylic copolymers and tackifiers, and a combination of these with the grafted polyolefins mentioned, are suitable adhesion promoters. The amount of grafted polyolefin adhesion promoter is such that the weight of incorporated maleic acid or maleic anhydride comprises from about 0.05% to about 2% by weight, and preferably from 0.1 to 1.5% based on the weight of the polyolefin sheath. The polyolefin can be polyethylene (PE), polypropylene (PP), polybutylene or a mixture of these. Suitable polyethylene may be high-density polyethylene (HDPE), medium density polyethylene (MDPE), low-density polyethylene (LDPE), linear low-density polyethylene (LLDPE), ultra low-density polyethylene (ULDPE), or a mixture of these. These polyolefins may be produced with either Ziegler-Natta or metallocene catalysts. The preferred bicomponent binder fiber is a maleic grafted LLDPE polyethylene sheath/polyester core bicomponent fiber available as Type 255 from INVISTA (Salisbury N.C. USA).

Suitable synthetic fibers, for the matrix, having properties that make a good batt for use as molded articles are: polyester, such as polyester terephthalate (PET), polybutylene terephthalate, polytrimethylene terephthalate and polycyclohexylenedimethylene terephthalate (PCT), and polyamide such as nylon 6 and nylon 6.6.

Other high modulus fibers such as glass, carbon, or basalt can be included in the matrix fibers, in an amount up to about 10% of the weight of the matrix fibers.

It has been found that the modulus (load at 10% elongation) of the matrix synthetic fiber affects the physical properties of the molded article. In particular improved properties are seen if the modulus of the matrix fiber is greater than 10 cN/tex. The modulus of synthetic staple fibers can be increased by heat setting under tension.

It has been found that the addition of filler, such as carbon black or titanium dioxide, to the sheath of the bicomponent fiber improves the sag of the bonded batt. Other fillers are graphite, talc, metal carbonates and sulfates, other inorganic particles, metal benzoates and stearates, benzoic acid, dibenzylidene sorbitol derivates, etc, or a mixture of two or more of these. The amount of filler may be in the range from about 0.1 to about 0.3 weight %, based on the weight of the low melting portion. In the case of carbon black and titanium dioxide, for example, a suitable amount is 0.2 weight % of the lower melting portion. Too much filler will cause the strength of the nonwoven/batt/molded article to decrease, while too little filler will not result in less sag (decrease the sag).

It has also been found that natural fibers can be used, in place of the polyester matrix fiber, with the adhesion promoted polyolefin/polyester bicomponent binder fiber to produce molded articles of improved physical properties. Natural fibers suitable for the present invention are wood pulp, kenaf, jute, flax, wool and cotton, with wood pulp preferred.

A molded article made from the nonwoven batt of the present invention has synthetic and/or natural fibers comprising from about 25-45 wt. % of said batt and bicomponent fiber comprising from about 55-75 wt. % of said batt.

### EXAMPLES

The molded articles were prepared by first preparing a nonwoven batt. Matrix and binder fibers were blended together in the required ratio and then carded into a web. This web was cut into sections and carded again at 90° orientation to the first pass. No needlepunching occurred. This web was then cut into 36×36 cm sections. The web was placed between two molding plates with a 5 mm spacer and the molding plates tightened. The assembly was then placed in an air oven at a set temperature for one hour. The assembly was allowed to cool to room temperature prior to the mold being opened. The molded board was cut into 8×30 cm strips, each of which was weighed to calculate the basis weight (grams/m², gsm). The thickness was measured with a micrometer.

The strength, stiffness and toughness of the molded boards were measured according to ASTM D790-98. The span was set at 152 mm, the roller diameter was 19 mm and the cross-head speed was 50 mm/min. The stiffness is defined as the initial steepest slope of the force-displacement curve, and reported as N/mm. The strength is the offset yield strength from the flexural load-displacement curve, using an offset yield at 1.27 mm, and reported in N. The toughness is defined as the load at 25.4 mm displacement, divided by the offset yield load, multiplied by 100, and reported as %.

The sag is measured with a cantilevered beam of a non-needlepunched molded article. The sample (8×30 cm) is clamped at one end leaving 28 cm unsupported. The distance from the top of the end of the unsupported strip to the bottom of the support stand is measured (L₀). The support stand is placed in an air oven at 91° C. for 22 hours, then removed and allowed to cool to room temperature. The same distance from the top of the end of the unsupported strip to the bottom of the support stand is measured (L₁). The sag is reported as (L₀-L₁) mm.

The modulus of the fibers is the load (cN/tex) at 10% elongation, using a 12.7 cm gauge length and a strain rate of 100%/min.

### Example 1

A blend of 35 wt. % 16.7 dtex/fil hollow (PET) polyester staple (modulus 9.7 cN/tex) and 65 wt. % bicomponent fibers was prepared and processed into molded boards with different basis weights, as discussed above. In sample 1 the bicomponent binder fiber was a standard 35% copolyester sheath/65% polyester core (INVISTA Type C58, modulus 5.3 cN/tex), representative of the prior art (Weinle) and the batt was molded at 185° C. In sample 2 the bicomponent binder fiber used a 50% maleic anhydride grafted polyethylene sheath with a 50% polyester core (INVISTA Type 255, modulus 6.2 cN/tex). The batt was molded at 155° C.

The physical properties are set forth in Table 1.

TABLE 1

| | Basis wt. | | Stiffness | | Toughness |
|---|---|---|---|---|---|
| Sample | (gsm) | Sag (mm) | (N/mm) | Strength (N) | (%) |
| 1 | 1000 | 11.9 | 2.4 | 20.8 | 88 |
| 1 | 1085 | 11.2 | 2.86 | 21.8 | 85 |
| 1 | 1109 | 10.3 | 2.95 | 18.5 | 85 |
| 1 | 1220 | 10.1 | 3.9 | 27.5 | 87 |
| 2 | 1014 | 7.2 | 2.73 | 17.5 | 77 |
| 2 | 1207 | 7.5 | 3.14 | 25.7 | 92 |
| 2 | 1214 | 7.2 | 3.48 | 30.7 | 91 |
| 2 | 1346 | 7.0 | 3.61 | 34.0 | 97 |
| 2 | 1505 | 6.6 | 5.82 | 40.6 | 96 |

These results show that the grafted polyethylene binder fiber of Sample 2 gave a molded article with reduced sag at all basis weights compared to Sample 1. There was not a significant difference between the stiffness and strength of molded strips from sample 1 and 2. At the same basis weight the grafted polyethylene binder fiber gave superior toughness.

### Example 2

In order to show the advantage of an adhesion promoted polyethylene sheath bicomponent binder fiber a third sample (#3) was prepared as in Example 1, but using an ungrafted polyethylene sheath/polyester core bicomponent fiber. The results are set forth in Table 2.

TABLE 2

| | Basis wt. | | Stiffness | | Toughness |
|---|---|---|---|---|---|
| Sample | (gsm) | Sag (mm) | (N/mm) | Strength (N) | (%) |
| 3 | 1020 | 13.6 | 2.1 | 13.2 | 79.8 |
| 3 | 1197 | 9.1 | 3.2 | 16.8 | 74.2 |
| 3 | 1309 | 9.7 | 3.4 | 23.2 | 82.3 |

These results show that the ungrafted polyethylene binder fiber gave poor sag performance, equivalent stiffness, poorer strength and toughness compared to Sample 2, at all basis weights.

### Example 3

Two variants of a 5.6 dtex/fil hollow matrix fiber were prepared, one with a modulus of 9.7 cN/tex and the other with a modulus of 22 cN/tex. Batts were prepared as in Example 1 using INVISTA T255 grafted PE sheath binder fiber (see Sample 2). The molded property results are set forth in Table 3.

TABLE 3

| Matrix | | | | | |
|---|---|---|---|---|---|
| Modulus | Basis wt. | | Stiffness | | Toughness |
| (cN/tex) | (gsm) | Sag (mm) | (N/mm) | Strength (N) | (%) |
| 9.7 | 966 | 10.3 | 2.15 | 15.6 | 83.6 |
| 9.7 | 970 | 9.7 | 2.10 | 17.6 | 79.8 |
| 9.7 | 1000 | 13.1 | 2.63 | 19.7 | 78.7 |
| 9.7 | 1017 | 10.3 | 3.14 | 22.1 | 78.4 |
| 9.7 | 1085 | 12.0 | n.m | n.m | n.m |
| 9.7 | 1085 | 11.2 | n.m | n.m | n.m |
| 9.7 | 1115 | 8.4 | 3.14 | 22.1 | 78.4 |
| 9.7 | 1139 | 7.7 | 3.36 | 20.9 | 80.3 |
| 9.7 | 1197 | 8.7 | 3.00 | 23.5 | 77.3 |
| 9.7 | 1241 | 9.6 | 3.15 | 28.1 | 96.4 |
| 9.7 | 1325 | 9.8 | 3.82 | 34.5 | 93.9 |
| 22 | 959 | 7.4 | 2.43 | 12.5 | 77.7 |
| 22 | 1014 | 7.2 | 2.73 | 17.5 | 77.7 |
| 22 | 1037 | 8.0 | 3.15 | 18.9 | 80.6 |
| 22 | 1156 | 7.7 | 3.10 | 23.6 | 93.9 |
| 22 | 1166 | 7.7 | 3.36 | 21.4 | 92.0 |
| 22 | 1207 | 7.5 | 3.14 | 25.7 | 92.0 |
| 22 | 1214 | 7.2 | 3.48 | 30.7 | 91.3 |
| 22 | 1346 | 7.0 | 3.60 | 34.0 | 97.0 |
| 22 | 1505 | 6.6 | 5.82 | 40.6 | 96.2 |

n.m.-not measured

The results show that the higher modulus matrix fiber had significantly lower sag at all basis weights with comparable stiffness, strength and toughness.

### Example 4

Example 3 was repeated using the Type C58 copolyester/polyester bicomponent fiber, and the results shown in Table 4.

TABLE 4

| Matrix | | |
|---|---|---|
| Modulus | Basis wt. | |
| (cN/tex) | (gsm) | Sag (mm) |
| 9.7 | 1000 | 11.9 |
| 9.7 | 1085 | 11.2 |
| 9.7 | 1109 | 10.3 |
| 9.7 | 1220 | 10.1 |
| 22 | 1007 | 9.7 |
| 22 | 1048 | 9.0 |
| 22 | 1061 | 10.4 |
| 22 | 1261 | 7.5 |
| 22 | 1275 | 7.2 |
| 22 | 1383 | 8.8 |
| 22 | 1454 | 8.0 |

Again the higher modulus matrix fiber reduced sag.

### Example 5

In this example, both the matrix fiber and the core of the bicomponent fiber was polycyclohexylenedimethylene terephthalate (PCT). The PCT matrix solid fiber had a modulus of 14.6 cN/tex and a dtex/fil of 5.3. The sheath was 50 wt-% of grafted linear low density polyethylene grafted with maleic anhydride. The blend ratio was 65 wt-% bicomponent and 35 wt-% matrix. The batt was molded at 155° C. The physical properties of the molded batt are set forth in Table 5.

TABLE 5

| Basis wt. | | Stiffness | | |
|---|---|---|---|---|
| (gsm) | Sag (mm) | (N/mm) | Strength (N) | Toughness (%) |
| 980 | 9.2 | 1.5 | 16.1 | 100 |
| 983 | 7.7 | 1.6 | 16.6 | 94 |
| 1122 | 7.7 | 2.0 | 21.6 | 108 |
| 1139 | 9.1 | 2.0 | 21.2 | 108 |
| 1353 | 6.2 | 2.9 | 30.9 | 109 |

In comparison with the physical properties of a PET based molded batt (Example 3), the use of PCT, given basis weight, improves sag and toughness but at the expense of stiffness.

### Example 6

In this example the use of wood pulp as the matrix fiber in place of polyester was studied, using an airlay nonwoven process. The bicomponent fiber was 2.2 dtex/fil×6 mm INVISTA Type 255 (grafted PE sheath) and the wood pulp is obtained from processing 10 cm Weyco NF-401 on a Kamas hammer mill. The bicomponent fiber and wood pulp were metered and fed separately to a forming head typically found in any airlay equipment set-up. The blended fiber/wood pulp matt is partially cured in a through air oven to allow subsequent handling. The ratio of wood pulp to bicomponent fiber was 30:70. The sample preparation was similar to what has been described above with the exception of the carding step. As a control, a PET fiber (16.7 dtex/fil hollow, 6 mm fiber with a modulus of 9.7 cN/tex) was used as the matrix fiber in place of wood pulp. The physical properties of the molded strips are set forth in Table 6.

TABLE 6

| | Basis wt. | Sag | Stiffness | | Toughness |
|---|---|---|---|---|---|
| Matrix | (gsm) | (mm) | (N/mm) | Strength (N) | (%) |
| Wood pulp | 983 | 12.2 | 2.06 | 14.7 | 101 |
| Wood pulp | 1034 | 10.0 | 2.23 | 17.0 | 105 |
| Wood pulp | 1132 | 8.5 | 3.14 | 19.0 | 100 |
| Wood pulp | 1187 | 7.4 | 3.67 | 21.0 | 104 |
| Polyester | 1200 | 14.8 | 2.53 | 21.0 | 92 |
| Polyester | 1431 | 7.1 | 4.69 | 31.4 | 89 |

At comparable basis weight, the wood pulp matrix gave lower sag, equivalent stiffness and strength, and superior toughness than the PET matrix blend.

### Example 7

In this example a wet laid nonwoven process was used. The bicomponent fiber and wood pulp were stirred in a tank of water before being deposited onto a moving inclined belt. The web was then dried and partially bonded on a honeycomb drum dryer to allow subsequent handling. The ratio of wood pulp to bicomponent fiber was 35:65. The wood pulp was Rayocel HF (Rayonnier), and the bicomponent fiber was 4.4 dtex/fil, 32 mm INVISTA T255 (50% grafted linear polyethylene sheath, PET core). As a control, an INVISTA T103 PET fiber (6.7 dtex/fil solid, 19 mm fiber with a modulus of 25.6 cN/tex) was used as the matrix fiber in place of wood pulp. The physical properties of the molded strips are set forth in Table 7.

TABLE 7

| | Basis wt. | Sag | Stiffness | | Toughness |
|---|---|---|---|---|---|
| Matrix | (gsm) | (mm) | (N/mm) | Strength (N) | (%) |
| Wood pulp | 959 | 9.5 | 2.12 | 15.6 | 96 |
| Wood pulp | 966 | 8.8 | 2.04 | 16.7 | 96 |
| Wood pulp | 1085 | 8.6 | 2.59 | 20.4 | 97 |
| Wood pulp | 1373 | 6.1 | 3.84 | 32.0 | 111 |
| Wood pulp | 1383 | 6.7 | 4.20 | 34.6 | 107 |
| Polyester | 912 | 11.0 | 1.62 | 12.1 | 79 |
| Polyester | 1000 | 10.8 | 1.96 | 14.4 | 77 |
| Polyester | 1153 | 8.5 | 2.65 | 22.5 | 84 |
| Polyester | 1251 | 8.2 | 3.1 | 24.1 | 82 |

As in the case of the air laid nonwoven batts (Example 6), at comparable basis weight, the wood pulp matrix gave lower sag, equivalent stiffness and strength, and superior toughness than the PET matrix blend.

### Example 8

A blend of 35 wt. % 16.7 dtex/fil hollow (PET) polyester staple (modulus 9.7 cN/tex, cut length 7.6 cm) and 65 wt. % bicomponent fibers was prepared and processed into molded boards with different basis weights, as discussed above. The bicomponent binder fiber used a 50% maleic anhydride grafted polyethylene sheath with a 50% polypropylene core (4.4 dtex, cut length 6.3 cm). The batt was molded at 155° C. for 1 hour.

The physical properties are set forth in Table 8.

TABLE 8

| | | Stiffness | | |
|---|---|---|---|---|
| Basis wt. (gsm) | Sag (mm) | (N/mm) | Strength (N) | Toughness (%) |
| 1024 | 18.1 | 1.79 | 14.2 | 91 |
| 1071 | 16.6 | 2.16 | 16.8 | 86 |
| 1105 | 14.0 | 2.28 | 20.4 | 93 |
| 1163 | 13.8 | 2.73 | 23.8 | 94 |

The use of a polypropylene core in place of a polyester core resulted in poor sag.

### Example 9

A blend of 35 wt. % 16.7 dtex/fil hollow (PET) polyester staple (modulus 9.7 cN/tex, cut length 7.6 cm) and 65 wt. % bicomponent fibers was prepared and processed into molded boards with different basis weights, as discussed above. In sample 4 the bicomponent binder fiber was a 40% maleic anhydride grafted polypropylene sheath/60% polyester core (4.4 dtex, 6.3 cm cut length). In sample 5 the bicomponent binder fiber used a 40% polypropylene sheath with a 60% polyester core. The batts were molded at 185° C. for 1 hour.

The physical properties are set forth in Table 9.

TABLE 9

| | Basis wt. | | Stiffness | | Toughness |
|---|---|---|---|---|---|
| Sample | (gsm) | Sag (mm) | (N/mm) | Strength (N) | (%) |
| 4 | 986 | 9.6 | 1.97 | 14.7 | 77 |
| 4 | 990 | 12.5 | 2.16 | 17.2 | 78 |
| 4 | 1041 | 8.8 | 2.56 | 20.4 | 81 |
| 4 | 1054 | 8 | 2.42 | 17.9 | 81 |
| 4 | 1136 | 7.6 | 2.84 | 20.9 | 91 |
| 5 | 970 | 10.4 | 1.63 | 10.1 | 77 |
| 5 | 1064 | 8.2 | 2.47 | 15.2 | 75 |
| 5 | 1102 | 8.2 | 2.29 | 12.9 | 84 |
| 5 | 1115 | 7.7 | 2.75 | 17.1 | 82 |

The maleic anhydride grafted polypropylene sheath exhibited improved strength and stiffness, and comparable sag to the unmodified polypropylene sheath.

### Example 10

A blend of 35 wt. % 16.7 dtex/fil hollow (PET) polyester staple (modulus 9.7 cN/tex, cut length 7.6 cm) and 65 wt. % bicomponent fibers was prepared and processed into molded boards with different basis weights, as discussed above. Sample 6 used a bicomponent binder comprising a 50% maleic anhydride grafted polyethylene sheath with a 50% polyester core (INVISTA Type 255, modulus 6.2 cN/tex). Sample 7 used the same sheath to which 0.18 weight % carbon black was added. The batts were bonded at 155 ° C. for 1 hour.

The physical properties are set forth in Table 10.

TABLE 10

| | Basis wt. | | Stiffness | | Toughness |
|---|---|---|---|---|---|
| Sample | (gsm) | Sag (mm) | (N/mm) | Strength (N) | (%) |
| 6 | 1037 | 10.2 | 2.32 | 20.9 | 87 |
| 6 | 1069 | 9.5 | 2.42 | 21.7 | 89 |
| 6 | 1183 | 9.7 | 3.06 | 28.8 | 73 |
| 7 | 905 | 11.4 | 1.72 | 14.1 | 80 |
| 7 | 942 | 9.9 | 2.19 | 17.5 | 77 |
| 7 | 1007 | 10 | 2.31 | 19.9 | 81 |
| 7 | 1037 | 8.9 | 2.45 | 20.0 | 78 |
| 7 | 1041 | 7 | 2.70 | 19.4 | 80 |

Surprisingly the addition of carbon black to the sheath (Sample 7) decreased the sag at the constant basis weight.

### Example 11

A blend of 35 wt. % 16.7 dtex/fil hollow (PET) polyester staple (modulus 9.7 cN/tex, cut length 7.6 cm) and 65 wt. % bicomponent fibers was prepared and processed into molded boards with different basis weights, as discussed above. Sample 8 used a bicomponent binder comprising a 35% maleic anhydride grafted polyethylene sheath with a 65% polyester core. Sample 9 used the same sheath to which 0.175 weight % titanium dioxide (filler) was added. The batts were bonded at 155 ° C. for 1 hour.

The physical properties are set forth in Table 11.

TABLE 11

| | Basis wt. | | Stiffness | | Toughness |
|---|---|---|---|---|---|
| Sample | (gsm) | Sag (mm) | (N/mm) | Strength (N) | (%) |
| 8 | 986 | 10.8 | 2.13 | 14.7 | 83 |
| 8 | 997 | 9.8 | 2.34 | 16.1 | 78 |
| 8 | 1010 | 9.4 | 2.40 | 21.4 | 80 |
| 8 | 1020 | 11.2 | 2.59 | 19.7 | 83 |
| 8 | 1095 | 8.2 | 2.89 | 27.4 | 83 |
| 8 | 1163 | 8.1 | 2.87 | 25.1 | 91 |
| 8 | 1186 | 6.7 | 3.46 | 31.8 | 89 |
| 9 | 942 | 7.9 | 2.26 | 16.1 | 75 |
| 9 | 1024 | 6.2 | 2.56 | 18.3 | 77 |
| 9 | 1058 | 7.6 | 3.05 | 21.2 | 84 |
| 9 | 1166 | 6.9 | 3.54 | 25 | 83 |

Surprisingly the addition of a different filler, titanium dioxide, to the sheath (Sample 9) also decreased the sag at a constant basis weight.

Thus it is apparent that there has been provided, in accordance with the invention, a process that fully satisfied the objects, aims and advantages set forth above. While the invention has been described in conjunction with specific embodiments thereof, it is evident that many alternatives, modifications and variations will be apparent to those skilled in the art in light of the foregoing description. Accordingly, it is intended to embrace all such alternatives, modifications and variations as fall within the spirit and broad scope of the appended claims.

What is claimed is:

1) A nonwoven batt suitable for use in a molded article comprising: a blend of synthetic and/or natural fibers, and bicomponent fiber, said bicomponent fiber having a low melting portion that is adhesion promoted polyolefin, wherein the sag of a molded non-needlepunched batt, at 91° C. is less than 10 mm measured when the weight range of the batt is 1000 to 1200 grams per square meter, cantilevering a distance of 28 cm.

2) The batt of claim 1, wherein said synthetic fiber has a modulus of at least 10 cN/tex.

3) The batt of claim 2, wherein said synthetic fiber is selected from the class of polyester or polyamide.

4) The batt of claim 1, wherein said adhesion promoted polyolefin is maleic anhydride grafted polyethylene.

5) The batt of claim 1, wherein said natural fiber is selected from the class of wood pulp, jute, kenaf, wool, cotton or flax.

6) The batt of claim 1, wherein said synthetic and/or natural fibers comprise from about 25-45 wt % of said batt and said bicomponent fiber comprise from about 55-75 wt % of said batt.

7) The batt of claim 1, wherein said low melting component of said bicomponent fiber contains filler.

8) The batt of claim 7, wherein said filler is carbon black or titanium dioxide.

9) The batt of claim 7, wherein said filler is present in an amount of from about 0.1 to about 0.3 weight % of said low melting portion, and said low melting portion is about 50 weight % of said bicomponent fiber.

10) A nonwoven batt suitable for use in a molded article comprising: a non-needlepunched blend of synthetic polyester and/or natural fibers comprising from about 25-45 wt % of said batt, and bicomponent fiber comprising from about 55-75 wt % of said batt, said bicomponent fiber having a low melting portion that is adhesion promoted polyolefin and said low melting portion is about 50 weight % of said bicomponent fiber.

11) The batt of claim 10, wherein said polyester fiber has a modulus of at least 10 cN/tex.

12) The batt of claim 10, wherein said adhesion promoted polyolefin is maleic anhydride grafted polyethylene.

13) The batt of claim 10, wherein the sag of a molded batt at 91° C. is less than 10 mm measured when the weight range of the batt is 1000 to 1200 grams per square meter, cantilevering a distance of 28 cm.

14) A molded article comprising a blend of synthetic and/or natural fibers, and bicomponent fiber, said bicomponent fiber having a low melt portion that is adhesion promoted polyolefin, wherein the sag of the said molded article, non-needlepunched, at 91° C. is less than 10 mm measured when the weight range of the batt is 1000 to 1200 grams per square meter, cantilevering a distance of 28 cm.

15) The molded article of claim 14, wherein synthetic and/or natural fibers comprise from about 25-45 wt % of said blend and said bicomponent fiber comprise from about 55-75 wt % of said blend.

16) The molded article of claim 14, wherein said synthetic fiber is selected from the class of polyester or polyamide.

17) The molded article of claim 14, wherein said adhesion promoted polyolefin is maleic anhydride grafted polyethylene.

18) The molded article of claim 14, wherein said natural fiber is selected from the class of wood pulp, jute, kenaf, wool, cotton or flax.

19) The molded article of claim 14, wherein said synthetic fiber has a modulus of at least 10 cN/tex.

20) The molded article of claim 14, wherein said low melting component of said bicomponent fiber contains filler.

21) The molded article of claim 20, wherein said filler is carbon black or titanium dioxide.

22) The molded article of claim 20, wherein said filler is present in an amount of from about 0.1 to about 0.3 weight % of said low melting portion, and said low melting portion is about 50 weight % of said bicomponent fiber.

23) A molded article suitable for use in a vehicle headliner comprising: a blend of synthetic polyester and/or natural fibers comprising from about 25-45 wt % of said blend, and bicomponent fiber comprising from about 55-75 wt % of said blend, said bicomponent fiber having a low melting portion that is adhesion promoted polyolefin and said low melting portion is about 50 weight % of said bicomponent fiber.

24) The molded article of claim 23, wherein said polyester fiber has a modulus of at least 10 cN/tex.

25) The molded article of claim 23, wherein the sag of the said molded article, non-needlepunched, at 91 ° C. is less than 10 mm measured when the weight range of the batt is 1000 to 1200 grams per square meter, cantilevering a distance of 28 cm.

26) The batt of claim 7, wherein said filler is graphite, talc, metal carbonates and sulfates, other inorganic particles, metal benzoates and stearates, benzoic acid, dibenzylidene sorbitol derivates, titanium dioxide, carbon black, or a mixture of two or more of these.
